(19) United States
(12) Patent Application Publication
(10) Pub. No.: US 2002/0056128 A1
(43) Pub. Date: May 9, 2002

(54) Establishment of upstream connection in wired network

(76) Inventor: Risto Makipaa, Otava (FI)

Correspondence Address: A. Blair Hughes, McDonnell Boehnen Hulbert & Berghoff, 32nd Floor, 300 S. Wacker Drive, Chicago, IL, 60606, US

(21) Appl. No.: 10/032,905

(22) Filed: Nov. 1, 2001

Related U.S. Application Data
(63) Continuation of application No. PCT/FI00/00463, filed on May 23, 2000.

(30) Foreign Application Priority Data
May 24, 1999 (FI) 991178

(51) Int. Cl. H04N 7/16; H04N 7/18; H04N 7/173

(52) U.S. Cl. 725/98; 725/74; 725/62

(57) ABSTRACT

A telecommunications system comprising a broadband and a narrower-band wired network for transmitting broadcast and on-demand services, and a network adapter between these two. The narrower-band wired network is used for relaying services to terminals which are connected to a transceiver in a wireless telecommunications network. The network adapter is in turn connected to a base station in the wireless telecommunications network, data transmission from the terminal to the broadband wired network being arranged to take place through the network adapter in the wireless telecommunications network. The network adapter or a network control device connected to the broadband network is additionally arranged to generate signalling parameters needed for connection set-up in the wireless telecommunications network for transmission to the terminal in a multiplexed service broadcast.

This application is a Continuation of International Application PCT/FI00/00463 filed May 23 2000 which designated the U.S. and was published under PCT Article 21(2) in English.

The invention relates to a telecommunications system comprising a broadband wired network and a narrower-band wired network for transmitting broadcast and on-demand services, and a network adapter between these two, the narrower-band wired network being arranged to transmit the services to at least one terminal.

In the next few years, new digital broadcast networks will be introduced for transmitting radio and television broadcasts. These networks include a Digital Audio Broadcasting network (DAB) and a Digital Video Broadcasting network (DVB). The DAB and DVB networks will also comprise bidirectional, interactive services that enable for example chargeable services to be ordered or response data relating to a service to be sent from a network terminal. Such interactive services include electronic commerce, various games and video-on-demand services, and they require the terminal to be equipped with means for upstream transmission, i.e. to transmit to the network. The terminal concerned usually has a wired connection to a fixed network, such as the Public Switched Telephone Network (PSTN), which is further connected to the DAB or DVB network.

The services available in these digital broadcast networks can also be transmitted through cable networks, in which case the upstream transmissions relating to interactive services can be arranged to be carried out by a home terminal, such as a Set-Top Box (STB), for example, equipped with a cable modem and connected between the cable network and the terminal. With the STB it is possible to use the current analog TV and radio receivers to receive digital broadcasts or Internet services. The terminal can also be integrated into a computer using for example different PC receiver cards. The cable network is implemented as a Hybrid Fiber Coax (HFC), i.e. a combination of an optical fiber and coaxial cable, program services being relayed from the network's headend equipment to an Interactive Network Adapter (INA), typically over an optical fiber, using for example ATM transfer (Asynchronous Transfer Mode). The services are further transferred from the adapter to a cable network of a smaller area comprising for example a block of flats, or a number of detached or semi-detached houses. The function of the interactive network adapter INA is to adapt the ATM protocol to suit the terminal, such as the STB, in the downstream connection and to perform an adaptation in the reverse direction to allow upstream transmissions to be relayed from the terminals to the service providers through the ATM network. The cable networks in smaller areas, such as common antenna cables in blocks of flats, are usually implemented as coaxial cable networks in a tree or star configuration. They are fairly well suited for unidirectional data transmission, although signal attenuation occurs often in coaxial cable networks, and signals are also easily affected by external radio disturbances.

A problem with the above described arrangement is how to arrange bi-directional broadcasts in cable networks of smaller areas. Introduction of upstream transmissions into a common antenna arrangement of a block of flats, for example, increases noise in the network and the so-called RF-ingress loss, thereby narrowing the bandwidth in the upstream direction. The connection available from the network adapter INA to the service providers, i.e. to the headend equipment, is implemented through a broadband, typically optical fiber network, where upstream transmissions do not cause similar problems. Hence, local narrowband coaxial cable networks form the bottleneck for upstream transmissions.

It is an object of the present invention to provide a telecommunications system that allows the above described problems to be avoided.

The arrangement of the invention is characterized in that

the network adapter is operationally connected to a base station in a wireless telecommunications network;

the terminal is operationally connected to a transceiver in the wireless telecommunications network; and

data transmission from the terminal to the broadband wired network is arranged to be take place through the network adapter in the wireless telecommunications network.

An essential idea of the invention is that the network adapter between the broadband and narrowband wired networks is connected to a wireless base station, and the terminals of the narrowband network are provided with wireless transmitters compatible with the base station, thereby allowing wireless upstream transmissions to be relayed in the narrowband network. A further idea of the invention is that the signalling parameters needed for establishing a wireless upstream connection are generated at the network adapter and relayed from there to the terminals through the narrowband wired network, multiplexed to service broadcasts. According to a preferred embodiment of the invention, the signalling parameters can also be generated at a network management device arranged at the headend equipment. Another preferred embodiment of the invention is based on the idea that the terminal can function as a server for a wireless multimedia network designed typically for home environment. The idea of a still further preferred embodiment of the invention is that the signalling parameters for traffic channels in the multimedia network are generated at the network adapter and relayed from there to the terminals through the narrowband wired network, multiplexed to service broadcasts.

The invention provides significant advantages. The wireless upstream connection between the terminals and the network adapter allows a local narrowband cable network to be reserved for downstream transmissions alone, so that disturbances narrowing the bandwidth caused by upstream transmissions do not occur. Another advantage of the invention is that since the network adapter, or a similar control device, is used for controlling the wireless radio connections to be used, the radio connections of the terminals included in the entire narrowband cable network can be centrally managed in such a way that disturbances do not emerge. A further advantage is that the wireless upstream connection can be established for example using prior art wireless local area network components. A preferred embodiment of the invention also provides an advantage in that wireless signalling parameters of a multimedia network designed for home environment can be centrally managed at the network adapter. In addition, an advantage of this embodiment is that it allows the multimedia network to be quickly set up for example in offices or at fairs.

The invention will be described in greater detail with reference to the accompanying drawing, in which

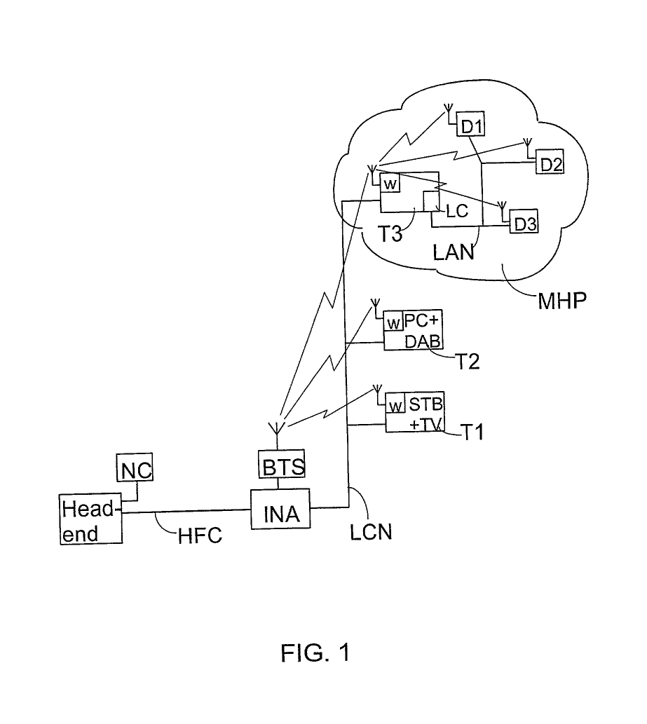

FIG. 1 illustrates a telecommunications system of the invention used for establishing a wireless upstream connection.

In FIG. 1, the program services and other services available in a cable network are relayed from a headend equipment over an optical fiber that allows broadband data transmission in a HFC network via an interactive network adapter INA to a narrower-band Local Cable Network LCN, which is typically implemented as a coaxial cable network. Downstream program supply is transferred further to terminals via the local cable network LCN which is usually implemented in a tree or star configuration. According to the invention, the local cable network LCN is connected to a wireless network base station BTS. The base station BTS can advantageously be a base station employing wireless local area network technology and broadband (e.g. 2.4 GHz) spread spectrum technology. The base station BTS can be arranged at the interactive network adapter INA, or it can have a wired connection to the adapter, in which case it is preferably centrally located in the local cable network LCN. Terminals T1, T2, T3 of the local cable network LCN are also equipped with wireless transceivers W which employ the same transmission technology as the base station, and which can establish a wireless connection to the base station BTS. The number of terminals T can naturally vary greatly.

According to the invention, signalling parameters are distributed to the terminals T1, T2, T3 through the cable network LCN, whereby the terminals can use the parameters and the wireless transceivers W connected to the terminals to establish an upstream connection to the base station BTS and, via the interactive network adapter INA, further to the service providers. The terminals T1, T2, T3 are preferably identified with identifying data on the basis of which the signalling parameters can be routed through the correct network adapter to the correct terminal. The identifying data are preferably the same as those used as terminal identifier data in subscriber-specific broadcast services. The management of signalling parameters can be take place either at the interactive network adapter INA or centrally at a network controller NC arranged at the headend equipment. When signalling parameters are generated at the network controller NC, an ATM network preferably connects the network adapter INA to the network controller NC which determines the parameter values, the headend equipment then multiplexing the values and the terminal identifier data into the broadcast service. Terminal-specific signalling parameter values can be multiplexed at the headend equipment preferably to a broadcast service of the DVB standard, the service being then transmitted further to the network adapter INA, which arranges the broadcast service and the terminal identifier and signal parameter data associated with the service into a multiplexed form which the terminals understand, such as a DVB-C (DVB-Cable) multiplexe. In spread spectrum technology all the signals to be transmitted are spread over the entire bandwidth available, and the signals are separated from each other preferably by means of various codes. If wireless upstream broadcasts are transmitted using spread spectrum technology, the signalling parameters comprise at least the signalling channel to be used, and preferably codes for separating the traffic channels to be used from each other.

With regard to the base stations serving the various local cable networks LCN, sufficient retransmission distance must be provided. Low-capacity base stations BTS located sufficiently far apart from each other can then preferably use the same frequency block. Through the cable network LCN the terminals receive at least the signalling channel codes and possibly also those of the traffic channels. The terminal can use the signalling channel codes for configuring with the base station BTS. If a plural number of base stations are to be located physically close to each other, different frequency blocks have to be allocated for them.

The terminal user receives interactive services as described above through the HFC network, signalling parameters for each terminal being multiplexed to the service broadcasts, preferably at the network adapter INA or in the headend equipment, to provide for a wireless upstream connection. The received interactive service allows for example response data to be sent from the terminal back to the service provider. When the terminal user wishes to send an upstream message, a wireless connection is established from the transceiver W arranged at the terminal to the base station BTS. The connection is set up using signalling channel codes transmitted through the cable network LCN, the codes allowing the terminal to establish a signalling connection to the base station BTS. The signalling connection is preferably used for transmitting to the terminal the traffic channel codes needed for relaying user data, and, after the connection set-up process for a traffic channel is completed, the traffic channel is allocated to the terminal for transmitting upstream messages. Alternatively, traffic channel codes can also be multiplexed to the service broadcasts and transmitted to the terminal through the cable network LCN from the network adapter INA, which speeds up connection set-up between the terminal and the base station BTS.

The terminals can be for example TV or radio terminals connected to the cable network via a set-top-box, as the terminal T1 shown in FIG. 1. In this case, the wireless transceiver W, such as a WLAN card of the IEEE standard 802.11, is integrated into the set-top-box. The terminal can also be a personal computer PC comprising for example the WLAN card and an interface card enabling DAB reception (terminal T2). Wireless data transmission between the terminal and the base station can naturally be implemented by applying any short range radio network solution.

According to a preferred embodiment of the invention, the above method for distributing signalling parameters can be applied in solutions used for example in home environment where diverse telecommunications and audiovisual services are integrated into one and the same, typically wireless, telecommunications network. This type of solution is referred to as a Multimedia Home Platform (MHP). In connection with the standardization of the DVB, a reference model has been designed for the MHP which describes the co-operation between multimedia terminals and various auxiliary devices, such as printers and mass memory units, the model covering for example the protocols to be used, interfaces between the devices and programming languages used for the interfaces. In the MHP model, a terminal T3, such as the above described set-top-box or PC provided with a DAB or DVB interface card, typically functions as the home network server and as the gateway to the cable network LCN. The introduction of the MHP further increases the need for upstream broadcasts from the home network to HFC network service providers, the invention enabling a wireless upstream connection to be set up from the terminal T3 of the MHP network.

When the wireless network is to be used to combine the diverse multimedia terminals of the MHP, its peripheral devices D1, D2, D3 and the terminal T3 acting as the server, a problem arises from how to separate radio frequency broadcasts sent by MHP networks located close to each other. In a preferred embodiment of the invention this problem is solved by arranging the traffic channel codes needed by the MHP network for reciprocal data transmission between the terminals and the auxiliary devices to be also relayed in a manner described above from the network adapter INA through the cable network LCN to the terminal acting as the server of the MHP network. This allows the network adapter INA or the network controller NC to control all MHP networks connected to one and the same local cable network LCN and the traffic channel parameters of the MHP networks. Hence it is possible to ensure that MHP networks located close to each other use different connection parameters and traffic channels, which allows disturbance caused by adjacent networks to be reduced. In addition, MHP networks can be rapidly set up because traffic channel codes do not need to be configured with each device separately. Moreover, setting up of temporary wireless MHP networks for example in offices or at fairs becomes significantly easier. The centralized control of the MHP networks further allows connection set-up requests to be sent through the HFC network to devices connected to the MHP network. For example, a video call request can be sent through the HFC network to a wireless surveillance camera in an MHP network, thereby allowing the picture transmitted by the camera to be examined through a video call connection.

The MHP network can also be implemented as a wired network, preferably as a local area network LAN, in which case the local network functions as a network combining the diverse multimedia terminals of the MHP, its auxiliary devices D1, D2, D3 and the terminal T3 acting as a server. Consequently, it is not necessary to distribute the traffic channel parameters of the wireless multimedia network, but an upstream connection can still be set up using a wireless connection from the terminal T3 to the network adapter INA. The terminal T3 must in this case be provided with means allowing wired communication from the terminal T3 through the local area network LAN to the multimedia terminals and auxiliary devices D1, D2, D3 of the MHP. These means can preferably comprise a local area network interface card LC.

The invention is described in the above specification and the accompanying drawing only by way of example, the invention not being in any way restricted to it. A person skilled in the art will find it apparent that the invention can also be used in any other similarly functioning wired network. Various embodiments of the invention are therefore possible within the scope of the accompanying claims.

1. A telecommunications system comprising a broadband wired network and a narrower-band wired network for transmitting broadcast and on-demand services, and a network adapter between these two, the narrower-band wired network being configured to transmit the services to at least one terminal, wherein
the network adapter is operationally connected to a base station of a wireless local area network operated by said broadband wired network;
the terminal is operationally connected to a transceiver of the wireless local area network; and
data transmission from the terminal to the broadband wired network is configured to be take place through the network adapter in the wireless local area network.

2. A telecommunications system according to claim 1, wherein
the network adapter is configured to generate the signalling parameters needed for connection set-up in the wireless local area network for transmission to the terminal in a multiplexed service broadcast.

3. A telecommunications system according to claim 1, wherein
a network control device connected to the broadband wired network is configured to generate the signalling parameters needed for connection set-up in the wireless local area network for transmission through the network adapter to the terminal in a multiplexed service broadcast.

4. A telecommunications system according to claim 2, wherein
the wireless local area network is based on spread spectrum technology and
the signalling parameters comprise at least codes for determining a signalling channel.

5. A telecommunications system according to claim 4, wherein
the terminal is configured to establish a wireless signalling connection to the base station for requesting a traffic channel, and
the base station is configured to transmit the codes needed for using the traffic channel to the terminal.

6. A telecommunications system according to claim 1, wherein
the broadband wired network, the narrower-band wired network and the network adapter between these two form an HFC network (Hybrid Fibre Coax), the broadband network being an optical fiber network and the narrowband network a coaxial cable network.

7. A telecommunications system according to claim 1, wherein
the terminal comprises a set-top-box connected to a TV or radio receiver.

8. A telecommunications system according to claim 1, wherein
the terminal comprises an audio or video interface card connected to a computer.

9. A telecommunications system according to claim 1, wherein
the terminal is configured to function as a server for a wireless multimedia network, such as an MHP network, and
the network adapter is configured to generate the codes needed for using the traffic channels in the wireless multimedia network for transmission to the terminal in a multiplexed service broadcast.

10. A telecommunications system according to claim 9, wherein
the terminal is configured to relay the codes needed for using the traffic channels in the wireless multimedia network to other devices in the multimedia network.

11. A telecommunications system according to claim 10, wherein
the terminal is configured to transmit messages addressed from other devices in the wireless multimedia network to the broadband wired network through the network adapter in the wireless local area network.

12. A network adapter connected between a broadband wired network and a narrower-band wired network, wherein
the network adapter is operationally connected to a base station of a wireless local area network operated by said broadband wired network; and
the network adapter is configured to relay the data transmission received via the base station from a terminal of the narrower-band wired network, said terminal being operationally connected to a transceiver of the wireless local area network, to the broadband wired network.

13. A terminal of a telecommunications system, wherein
terminal is configured to receive broadcast and on-demand services via a wired network, the terminal is operationally connected to a transceiver of a wireless local area network, and the terminal is configured to configure its wireless connection to the wired network according to signalling parameters received from said wired network.
